(19) United States
(12) Patent Application Publication
(10) Pub. No.: US 2024/0160221 A1
(43) Pub. Date: May 16, 2024

(54) Method for constructing episodic memory model based on rat brain visual pathway and entorhinal-hippocampal cognitive mechanism

(71) Applicant: BEIJING UNIVERSITY OF TECHNOLOGY, BEIJING (CN)

(72) Inventors: Naigong Yu, BEIJING (CN); Yishen Liao, BEIJING (CN); Zongxia Wang, BEIJING (CN); Hejie Yu, BEIJING (CN); Jianjun Yu, BEIJING (CN); Xudong Liu, BEIJING (CN); Ruihua Wang, BEIJING (CN)

(21) Appl. No.: 18/412,459

(22) Filed: Jan. 12, 2024

Related U.S. Application Data
(63) Continuation of application No. PCT/CN2022/114221, filed on Aug. 23, 2022.

(30) Foreign Application Priority Data
Aug. 28, 2021 (CN) 202110999152.7

(51) Int. Cl. G05D 1/243; G06V 20/50

(52) U.S. Cl. CPC G05D 1/2435; G06V 20/50; G05D 2105/87

(57) ABSTRACT

A method for constructing episodic memory model based on rat brain visual pathway and entorhinal-hippocampal structure mainly applied to environment cognition and navigation of an intelligent mobile robot to complete tasks of environment cognition map construction and target-oriented navigation is provided. The image information of the environment, the head-direction angle and speed of the robot are collected, and then the head-direction angle and speed of the robot are input into the entorhinal-hippocampal CA3 neural computational model to obtain the robot's precise position. The visual information is input into the computational model of the visual pathway to obtain the scene information in the current vision of the robot. The above two kinds of information are fused and stored in a cognitive node with the topological relationship. Utilizing scenario information to correct the path integration errors during the exploration process of the robot, thereby constructing the episodic cognitive map representing the environment.

### CROSS-REFERENCE TO RELATED APPLICATIONS

The present application is a continuation of the international application PCT/CN2022/114221 filed on Aug. 23, 2022, which claims the priority to the Chinese Patent Application No. 202110999152.7 filed on Aug. 28, 2021. The entire contents of the above identified applications are incorporated herein by reference.

### TECHNICAL FIELD

The invention belongs to the field of environmental cognition and navigation of the intelligent mobile robot, and in particular relates to a method for constructing episodic memory model based on rat brain visual pathway and entorhinal-hippocampal cognitive mechanism.

### BACKGROUND

Environmental perception and cognition is a basic skill of human and animal brains, and it is also a fundamental task and a key issue for autonomous mobile robots. Intelligent behavior like higher mammals is a necessary condition for it to be able to quickly and accurately achieve goal-oriented navigation in complex and unknown environments. How to endow robots with this ability is a common concern in the fields of artificial intelligence, robotics, and neuroscience.

Physiological studies have shown that the key to environmental cognition and navigation in rats lies in the existence of a variety of neuron cells with specific firing effects on space in the brain, mainly including: head-direction cells, stripe cells, grid cells, and object vector cells in the entorhinal cortex; dentate gyrus neurons, hippocampal CA3 place cells, and hippocampal CA1 place cells in the hippocampus. These neuron cells are also called spatial cells.

Seventy percent of mammalian perception information about the environment is collected through the visual pathway, and the information is further transmitted through the brain circuit to an organizational structure called the hippocampus that is responsible for environmental cognition. In the rat brain structure, speed and head-direction information are thought to be input to the entorhinal cortex in the medial temporal lobe. The visual information is transmitted through two neural pathways in the output nerve of the occipital lobe. One of the pathways for information transmission along the ventral side is called the ventral pathway. The main function of this part is object perception and recognition, so it is known as the “what pathway”; another pathway along the dorsal side is called the dorsal pathway, also known as the occipital pathway. It is specific to spatial perception, and encodes motion information, determines where objects are, and analyzes the spatial position information of objects in the scene. At the same time, it can give information about its relative external position, so it is also called “where pathway”. The visual information after the fusion of the ventral and dorsal pathways is considered to be input to the non-grid cell structure of the entorhinal cortex, and then sent to the hippocampus together with the position and head-direction information output by the entorhinal cortex.

In the hippocampus, the speed and head-direction information are first input to the neurons of the dentate gyrus, and then transmitted to the place cells in the hippocampal CA3 area of the hippocampus to realize the neuron representation of the spatial position. Then it is fused with visual information, transmitted to the place cells in the hippocampus CA1 area and stored, realizing the joint memory of the spatial environment and spatial position. Therefore, in the rat brain structure, the entorhinal-hippocampal CA3 structure is used to represent the position in the environment; the two visual pathways are used to represent the scenario information of the spatial environment; and the function of the hippocampal CA1 structure is to store two fusion information.

Despite the rapid development of artificial intelligence technology in recent years, the perception and cognitive ability of autonomous mobile robots at this stage are far from the level of humans and animals. Therefore, drawing on and simulating the environment perception and cognition mechanism of humans and animals, constructing environment perception and cognition models of autonomous mobile robots has become a hot issue in the research of intelligent mobile robots. Based on the physiological characteristics of the rat brain visual pathway and the entorhinal-hippocampus and its environmental cognition mechanism, the present invention is oriented towards the independent exploration of the intelligent mobile robot and its unknown environment, and proposes a method for constructing the episodic memory model of the intelligent mobile robot.

### SUMMARY

Traditional robot environment cognition and navigation models mainly face the following problems:
1. Previous related research work is discrete on the perception level, and it is difficult to provide enough information for mobile robot navigation in unknown dynamic environments.
2. Traditional behavioral learning methods have been unable to meet human requirements for robot intelligence, and it is difficult to provide sufficient information for robot navigation in complex and unknown environments.
3. Most of the previous cognitive models are based on symbolic knowledge representation, and the robot system with this type of cognitive model has weak action ability, poor adaptability, and scalability.

In order to solve the problem that the robot cannot effectively construct the cognitive map of environmental situation caused by above problems, the present invention proposes a method for constructing episodic memory model based on rat brain visual pathway and entorhinal-hippocampal cognitive mechanism, which mainly includes: 1. construction of entorhinal-hippocampal CA3 neural computing model; 2. construction of “what pathway” and “where pathway” visual pathway computing models; 3. construction of cognitive nodes imitating hippocampal CA1 place cells; 4. construction of episodic cognitive map based on cognitive node. First, collect the image information of the environment through the camera, collect the head-direction angle and speed information of the robot through the gyroscope and the encoder, and transmit the above information to the CPU. Among them, the head-direction angle and speed information is input into the entorhinal-hippocampus CA3 neural computing model to obtain the precise position of the robot; the visual information is input into the visual pathway computing model to obtain the scene information within the robot's field of view. The attribute and position information of the external environment objects from the two visual pathways are fused with the position and head-direction information output from the rat brain entorhinal-hippocampal CA3 neural computing model, and stored in the cognitive node with the topological structure relationship. The scenario information is used to correct the path integration error in the process of robot exploration, and then construct the episodic cognition map of environmental expression. The concrete workflow of the inventive method is as follows:
Step 1. Robot explores the environment, collects RGB image information of the environment through the camera, and collects head-direction angle and speed information of the robot through gyroscope and encoder;
Step 2. Input head-direction angle and speed information into the rat brain entorhinal-hippocampus CA3 neural computing model to obtain the position information of robot in the environment;
Step 3. Input RGB image information into the visual pathway calculation model to obtain the environmental features within the robot's field of view, including the number of objects in the environment, attribute information of the objects, the angles of the objects relative to the robot, and the distances between the objects and the robot;
Step 4. Construct cognitive nodes: the robot constructs a new cognitive node every time it moves, and continuously constructs cognitive nodes in the process of exploring environment. There are topological connections between adjacent cognitive nodes. Among them, the i-th cognitive nodes are represented by eⁱ, which are used to store current scenario information, position, and direction angle information, and eⁱ can be expressed as follows:

eⁱ{Φ₀ⁱ, (Xₑₙᵥⁱ, Yₑₙᵥⁱ), (nᵢ^{object}, {ρᵢⱼ}, {Φᵢⱼ}, {dᵢⱼ})} (1)

Wherein, Φ₀ⁱ represents the head-direction angle of the robot at the i-th cognitive node, (Xₑₙᵥⁱ, Yₑₙᵥⁱ) represents the position information of the robot in the environment at the i-th cognitive node, (nᵢ^{object}, {ρᵢⱼ}, {Φᵢⱼ}, {dᵢⱼ}), represents the environmental features within the robot's field of view at the i-th cognitive node, and nᵢ^{object} represents the number of objects at the i-th cognitive node, ρᵢⱼ represents the attribute of the j-th object at the i-th cognitive node, Φᵢⱼ represents the orientation angle of the j-th object at the i-th cognitive node relative to the robot, and dᵢⱼ represents the distance between the j-th object at the i-th cognitive node and robot.
Step 5. Construct a episodic cognition map of environmental expression. Further, step 5 includes the following steps,
S5.1 Through the similar scene measurement algorithm, establish the topological connection relationship between cognitive nodes with similar scenario information, so as to expand the topological connection relationship between adjacent cognitive nodes;
S5.2 Use the topological relationship among all cognitive nodes to correct the cumulative error of the head-direction angle and position of the mobile robot during the exploration process, and construct a topological cognitive map;
S5.3 Calculate the position of environmental objects in the physical coordinate system and calibrate them in the topological map to realize the construction of the environmental episodic cognitive map.

The present invention respectively constructs a position cognition model based on the entorhinal-hippocampus CA3 structure of the rat brain and an environment cognition model based on the visual pathway, and uses the scenario information to correct the path integral error of the position cognition model in the process of robot exploration, and then constructs episodic cognition map of the environment. Compared with the closed-loop detection method used in traditional SLAM, the object-level image matching imitating the mechanism of biological cognition has better robustness in complex, changeable and repeatable environments. Combining this closed-loop detection method with the correction algorithm of cumulative errors can obtain a more accurate environmental cognition map. Moreover, the bionic method of the present invention has low requirements on hardware and sensors, and the whole model has good scalability and adaptability, and is suitable for navigation in different indoor environments.

### DESCRIPTION OF DRAWINGS

FIG. 1 is the flowchart of the method for constructing episodic memory model based on rat brain visual pathway and entorhinal-hippocampal cognitive mechanism;

FIG. 2 is the diagram of the operation mechanism of large-scale spatial cognition based on periodic resetting of striped cells;

FIG. 3 is the conceptual diagram of the expression of grid cell firing rate generated by fringe wave oscillation interference generation;

FIG. 4 is the 3D rendering of hippocampal CA3 place cell plate firing;

FIG. 5 is the flowchart of object position recognition algorithm;

FIG. 6 is the rendering of using DPM algorithm to recognize objects in the actual physical environment;

FIG. 7 is the rendering of the constructed episodic cognition map.

### PREFERRED EMBODIMENT

The present invention will be described in detail below in conjunction with the accompanying drawings and examples.

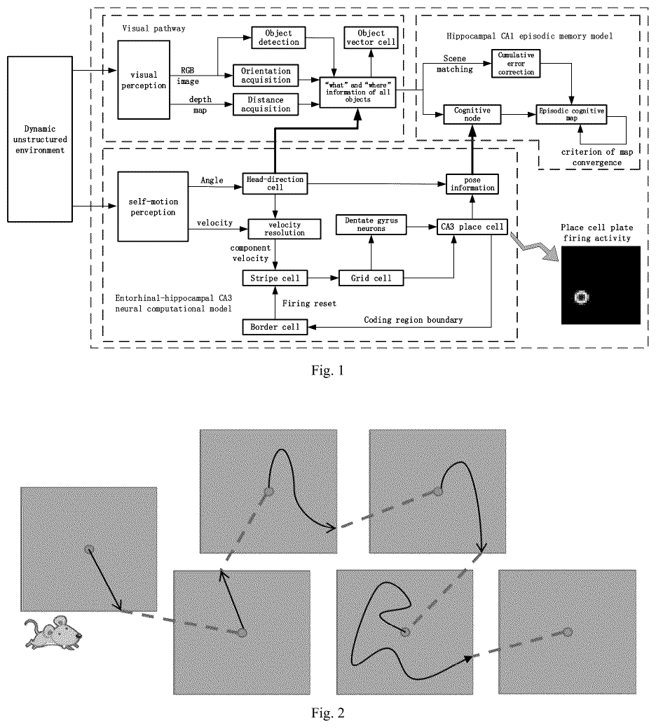

FIG. 1 is the flowchart of the method for constructing episodic memory model based on rat brain visual pathway and entorhinal-hippocampal cognitive mechanism. The method collects image information of environment through RGB-D camera, collects head-direction angle and speed information of robot through gyroscope and encoder, and transmits above information to the CPU. It constructs entorhinal-hippocampal CA3 neural computing model and the visual pathway computing model to obtain the position information of robot and scenario information of current environment respectively, and store them in the cognitive node to construct the episodic cognitive map of environment.

Specific steps are as follows:

### 1. Construction of Entorhinal-Hippocampal CA3 Neural Computing Model

Physiological studies have shown that speed and head-direction angle information are input to the hippocampal CA3 structure through the entorhinal-hippocampal information transmission pathway in rat brain, and form a representation of its own pose.

Based on this, the present invention proposes a method for constructing an entorhinal-hippocampal CA3 neural computing model, which obtains robot position information in a bionic manner.

Firstly, the mathematical expression of firing rate of stripe cells in two-dimensional space is given as:

Vₛₜᵣᵢₚₑ(t)=cos(2πf·∫v_{HD}dt)+cos(2πf_{d}·∫v_{HD}dt) (2)

In formula (2), t represents the time at the current moment, f represents the oscillation frequency of neuron cell body, and its value is randomly selected within the range of 0-256 Hz, f_{d} represents the oscillation frequency of neuron dendrites. ∫v_{HD}dt represents the path integral along the preferred direction angle Φ_{HD} of the stripe cells, where v_{HD} represents the component velocity of the rat at the preferred direction angle Φ_{HD}, and its mathematical expression is as follows:

v_{HD}=v cos(Φ−Φ_{HD}) (3)

In formula (3), v represents the current moving speed of the robot, and Φ represents the current head-direction angle of the robot. The meaning expressed by formula (2) is the interaction of waveforms corresponding to two frequencies, and a new waveform is presented in one-dimensional space, called stripe wave. The envelope of its waveform will have a relatively slow “beat” frequency, which is the oscillation frequency of the stripe wave. Set the frequency be f_{b}, and its mathematical expression is:

f_{b}=f_{d}−f (4)

The mathematical expressions of fringe wave oscillation frequency f_{b} and its mathematical expression is shown in formula (5):

f_{b}=v_{HD}/λ_{b}=B₁v cos(Φ−Φ_{HD}) (5)

In formula (4), λ_{b} represents wavelength of the stripe wave, and its value is randomly selected within the range of 0.05 m˜100 m, and B₁ represents the reciprocal of the stripe wave wavelength. Combining formula (3) and formula (5), the mathematical expression of neuron dendritic oscillation frequency f_{d} can be obtained as:

f_{d}=f+B₁v cos(Φ−Φ_{HD}) (6)

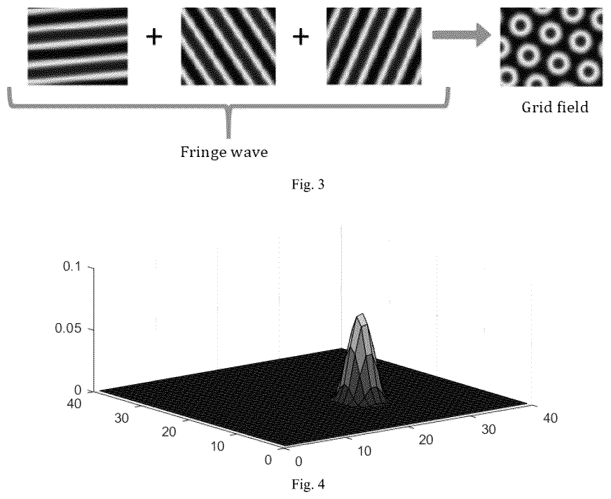

Physiological studies have shown that when the preferred direction angles of the three stripe cells differ by 120°, the stripe waves generated by them can spatially form a regular hexagonal grid field throughout the entire space through the oscillation interference mechanism in two-dimensional plane. FIG. 3 is a conceptual diagram of the expression of grid cell firing rate generated by fringe wave oscillation interference. Therefore, the mathematical expression of the firing rate of grid cells is:

g(t)=Π_{HD}(cos(2πf·∫v_{HD}dt)+cos(2π(f+Bv cos(Φ−Φ_{HD}))·∫v_{HD}dt)) (7)

In formula (7), the values of the three stripe cell preferred direction angles Φ_{HD} are Φ_{g}+0°, Φ_{g}+120°, Φ_{g}+240° respectively, where Φ_{g} represents the deviation angle of the stripe cells, and its value ranges from random selection within 0°˜360°. Φ_{g} also represents the orientation angle of the grid field. After the grid cell firing rate is obtained, it is used as the forward input signal of the dentate gyrus neurons, and the mathematical expression of the excitatory input signal transmitted by the grid cell group to the dentate gyrus neurons is:

$${I}_{i}^{M E C} ( t ) = {\sum }_{j = 1}^{{n}_{grid}} {W}_{ij} {g}_{j} ( t ) \qquad ( 8 )$$

In formula (8), i and j represent the numbers of dentate gyrus neurons and grid cells respectively, gⱼ(t) represents the firing rate of the j-th grid cell, and n_{grid} represents the number of grid cells.

W represents the excitatory input connection weight matrix, where Wᵢⱼ represents the connection weight from the j-th grid cell to the i-th dentate gyrus neuron, and the calculation formula of each connection weight is as follows:

$$W ( s ) = \frac{s}{0.2} ( \frac{s}{s + 0.0314} ) \qquad ( 9 )$$

In formula (9), s represents synapse size, and the value is randomly selected in the range of (0˜0.2)μm². Each size of s corresponds to its proportion in all synapses P(s) roughly obeys the following mathematical expression:

$$P ( s ) = {A}_{1} ( 1 - {e}^{- \frac{s}{{σ}_{1}}} ) ( {e}^{- \frac{s}{{σ}_{2}}} + {B}_{2} {e}^{- \frac{s}{{σ}_{3}}} ) \qquad ( 10 )$$

In formula (10), A=100.7, B=0.02, σ₁=0.022, σ₂=0.018, σ₃=0.15. The excitatory input connection weight matrix W can be assigned by formula (10) and formula (11), so as to realize the excitatory transmission from grid cells to dentate gyms neurons. Firing activity of dentate gyrus neurons within a given spatial region is subject to a WTA learning rule that describes competing activity arising from gamma-frequency feedback inhibition. The mathematical expression of the firing rate of dentate gyrus neurons is:

Fᵢ^{dentate}(t)=Iᵢ^{MEC}(t)·H(Iᵢ^{MEC}(t)−(1−k₁)·Iₘₐₓ^{MEC}) (11)

In formula (11), k₁ is 0.1, and its value determines which dentate gyrus neurons will be activated according to the WTA learning rule. Iₘₐₓ^{MEC} represents the maximum value of grid cell forward input received by dentate gyrus neurons. H(x) is a rectification function, when x>0, H(x)=1; otherwise, when x≤0, the function value is 0. After obtaining the firing rate expression of dentate gyrus neurons, the excitatory input signal Iᵢ^{dentate}(t) from dentate gyrus neurons to hippocampal CA3 place cells can be calculated, as shown in formula (12), and its calculation method is similar to formula (8).

$${I}_{i}^{d e n t a t e} ( t ) = {\sum }_{j = 1}^{{n}_{d e n t a t e}} {Ω}_{i j} \frac{{F}_{i}^{d e n t a t e} ( t )}{{F}_{max}^{d e n t a t e}} \qquad ( 12 )$$

In formula (12), i and j represent the serial numbers of hippocampal CA3 place cells and dentate gyrus neurons respectively, and n_{dentate} represents the number of dentate gyrus neurons, which is set to 1000. Fₘₐₓ^{dentate} represents the maximum firing rate of neurons in the dentate gyms. Since Fᵢ^{dentate}(t) is always greater than zero, dividing it by the maximum firing rate is similar to normalization. Ω represents the excitatory input connection weight matrix, where Ωᵢⱼ represents the connection weight from the j-th dentate gyrus neuron to the i-th hippocampal CA3 place cell, and the value ranges from 0-1. Distribution function of the connection weight value is defined as a non-negative Gaussian distribution, and the mathematical expression is as follows:

$$P ( Ω ) = {A}_{2} {e}^{- \frac{{( Ω - 1 )}^{2}}{2 {( σ / μ )}^{2}}} \qquad ( 13 )$$

In formula (13), A₂=1.033, μ=24, σ=13. The excitatory input connection weight matrix Ω can be assigned by formula (13), so as to realize the excitatory transmission from the dentate gyrus neurons to the hippocampal CA3 place cells. The hippocampal CA3 place cells of the hippocampus receive forward input from the neurons of the entorhinal cortex and the dentate gyrus at the same time, so the mathematical expression of the total excitatory input signal received by the hippocampal CA3 place cells is:

Iᵢ^{CA3}(t)=Iᵢ^{MEC}(t)+Iₐᵥ^{MEC}(t)Iᵢ^{dentate}(t) (14)

In formula (14), Iᵢ^{MEC}(t) and Iᵢ^{dentate}(t) are respectively the forward input signals of grid cells and dentate gyrus neurons mentioned above, and Iₐᵥ^{MEC}(t) represents the average strength of grid cell forward input signals, and its mathematical expression is:

$${I}_{a v}^{M E C} ( t ) = \frac{1}{{n}_{C A 3}} {\sum }_{i = 1}^{{n}_{C A 3}} [ \int {I}_{i}^{M E C} ( t ) dt ] \qquad ( 15 )$$

In formula (15), n_{CA3} represents the number of hippocampal CA3 place cells, which is set as 1600. Then the expression of firing rate of hippocampal place cells can be obtained, the mathematical expression is as follows, and the calculation method is similar to formula (10).

Fᵢ^{CA3}(t)=Iᵢ^{CA3}(t)·H(Iᵢ^{CA3}(t)−(1−k₂)·Iₘₐₓ^{CA3}) (16)

In formula (16), Iₘₐₓ^{CA3} represents the maximum value of the total excitation input signal received by hippocampal CA3 place cells, and the value of k₂ is 0.1. The information transfer mapping model from the entorhinal cortex to the CA3 region of the hippocampus can be established through formulas (2) to (16).

### 2. Construction of Position Recognition Model

In order to make the model have the ability of position cognition and realize quantification of place cell firing rate in the actual physical space, a spatial position recognition model composed of hippocampal CA3 place cells was established. Firstly, all hippocampal CA3 place cells were arranged in sequence into a cell plate model capable of representing position, and the shape of the cell plate was square. It can be seen from above that the number of hippocampal CA3 place cells is n_{CA3}, then the side length of the cell plate Nₓ=\sqrt{n_{CA3}}=40 and the corresponding coding area are set as a square area, the side length of the area is L, and the value is preferably in the range of 5 m˜20 m. Therefore, the mathematical expression of the place field center coordinates of each place cell is as follows:

$${r}_{i j} = ( \frac{L}{2 {N}_{x}} + ( i - 1 ) * \frac{L}{{N}_{x}} , \frac{L}{2 {N}_{x}} + ( j - 1 ) * \frac{L}{{N}_{x}} ) \qquad ( 17 )$$

In formula (17), i, j respectively represent the number of columns and rows of the current place cell on the cell plate, and rᵢⱼ represents the coordinates of the center of the place field of the place cell. Modeling hippocampal CA3 place cells as a square cell plate enables forward inputs generated by the entorhinal cortex to be represented on the plate as packets of excitatory activity. There is also an interaction between hippocampal CA3 place cells. In local connections, hippocampal CA3 place cells excite and inhibit surrounding cells through synaptic branches, and eventually the nerve cells with the strongest excitability win the competition, forming a single peak exciting activity pack. FIG. 4 is a diagram showing the hippocampal CA3 place cell plate firing effect.

A two-dimensional Gaussian distribution is used to create the excitability weight connection matrix ε_{m,n} of hippocampal CA3 place cells, where the subscripts m and n represent the distance between the horizontal and vertical coordinates of the unit in the coordinate system X and Y respectively, and its value are both set to 15. The mathematical expression of the weight distribution of the excitatory weight connection matrix is:

$${ε}_{m , n} = exp ( - \frac{{m}^{2} + {n}^{2}}{{k}_{p}} ) \qquad ( 18 )$$

In formula (18), kₚ represents the constant of position distribution width, and the value is 7. The amount of change in hippocampal CA3 place cell activity at time t due to local excitatory connections is:

$$Δ {P}_{E X , E Y}^{t} = {\sum }_{i = 0}^{{N}_{x} - 1} {\sum }_{j = 0}^{{N}_{x} - 1} {p}_{i , j}^{t} {ε}_{m , n} \qquad ( 19 )$$

In formula (19), p_{i,j}^{t} represents the firing rate of place cells in row i, column j on the cell plate at time t after interaction, and its initial value is the firing rate Fᵢ^{CA3}(t) of hippocampal CA3 place cells, and the output of inhibitory signals of hippocampal CA3 place cells occurs partly arousal works after connection, not simultaneously. The symmetry of excitatory and inhibitory connectivity matrices guarantees proper neural network dynamics, ensuring that attractors in space are not excited indefinitely. The activity change of hippocampal CA3 place cells caused by the inhibitory connection weight at time t is:

$$Δ {P}_{IX , IY}^{t} = {\sum }_{i = 0}^{{N}_{x}} {\sum }_{j = 0}^{{N}_{x}} {p}_{i , j}^{t} {ψ}_{m , n} - φ \qquad ( 20 )$$

In formula (20), ψ_{m,n} is the inhibitory connection weight, which controls the global inhibition level, and its value is 0.00002. Since the activities of all cells at hippocampal CA3 sites were non-zero and normalized, in order to ensure that the firing rate of all place cells at all times was not less than zero, the firing rate of all place cells was compared with 0, and the results were normalized, the mathematical expression is as follows:

$${p}_{i , j}^{t + 1} = max \{ {p}_{i , j}^{t} + Δ {P}_{E X , E Y} + Δ {P}_{IX , IY} , 0 \} \qquad ( 21 )$$

$${p}_{i , j}^{t + 1} = \frac{{p}_{i , j}^{t}}{{\sum }_{i = 0}^{{N}_{x}} {\sum }_{j = 0}^{{N}_{x}} {p}_{i , j}^{t}} \qquad ( 22 )$$

t and t+1 in formulas (21) and (22) represent the current moment and the next moment respectively. Through the modeling method of formula (16) to formula (21), the forward input from the entorhinal cortex can be represented on the cell plate in the form of excitatory activity packets. Then by obtaining the position of the exciting activity package on the cell plate, position of the current robot in space area encoded by the cell plate at the current position can be obtained, and the mathematical expression is as follow:

$$\{ \begin{matrix}{P}_{x}^{t} = {N}_{x} arctan ( \frac{{\sum }_{j = 1}^{{N}_{x}} ( sin ( \frac{2 j π}{{N}_{x}} ) {\sum }_{i = 1}^{{N}_{x}} {p}_{i , j}^{t} )}{{\sum }_{j = 1}^{{N}_{x}} ( cos ( \frac{2 j π}{{N}_{x}} ) {\sum }_{i = 1}^{{N}_{x}} {p}_{i , j}^{t} )} ) / 2 π \\ {P}_{y}^{t} = {N}_{x} arctan ( \frac{{\sum }_{i = 1}^{{N}_{x}} ( sin ( \frac{2 i π}{{N}_{x}} ) {\sum }_{j = 1}^{{N}_{x}} {p}_{i , j}^{t} )}{{\sum }_{i = 1}^{{N}_{x}} ( cos ( \frac{2 i π}{{N}_{x}} ) {\sum }_{j = 1}^{{N}_{x}} {p}_{i , j}^{t} )} ) / 2 π\end{matrix} \qquad ( 23 )$$

In formula (23), Pₓ^{t} and P_{y}^{t} represent the abscissa and ordinate of the excitatory activity packet on the place cell plate at time t, respectively. In order to make the model not limited to the spatial cognition in the encoding area, border cells with specific firing effects on the area boundary were introduced. Border cell firing stimulates a resetting of stripe cell firing activity when an encoded region boundary is reached, enabling rats to recognize position within arbitrarily sized spatial regions.

The specific implementation method is as follows: at the initial moment, the rat is set to be located in the center of the square area encoded by the place cell plate, and when the rat reaches any boundary of the given encoding area space, the path integration ∫v_{HD}dt of all stripe cells in the direction of preferred angle Φ_{HD} is set to zero, so that the rat is in the center of the positive direction area coded by the place cell plate after reset. In this way, every time the firing reset of stripe cells is completed, the place cell plate can immediately generate a code for a new spatial region, thereby completing the robot's position cognition for any size space.

The initial position of the robot movement is located in the center of the square area encoded by the place cell plate. The physical coordinate system is defined with the initial movement position as origin, and the horizontal direction of place cell plate is positive direction of X-axis. The physical coordinate systems mentioned below are all for this coordinate system. Then the mathematical expression of the position coordinates (Xₑₙᵥ^{t}, Yₑₙᵥ^{t}) of the robot in any size space area is as follows:

$$( {X}_{env}^{t} , {Y}_{e n v}^{t} ) = ( β ( {P}_{x}^{t} - \frac{{N}_{x}}{2} ) + {Q}_{x} , β ( {P}_{y}^{t} - \frac{{N}_{x}}{2} ) + {Q}_{y} ) \qquad ( 24 )$$

In formula (24), β is the proportional coefficient for transforming the coordinates on the place cell plate to the real position coordinates, and its value is the ratio of side length L of the square coding area to the side length Nₓ of the place cell plate.

Q_{X} and Q_{Y} respectively represent the horizontal and vertical coordinates of the rat in any size space area when the place cell plate was reset last time. The position of the rat in any size of the space area can be obtained through the above calculation, which provides accurate position information for the construction of the subsequent cognitive node.

### 3. Construction of Visual Pathway Calculation Model

The purpose of constructing visual pathway calculation model is scenario cognition, that is, when the robot explores in the environment, it can first accurately identify the attributes of all objects in current field of view and simulate the function of the “what pathway”; then, for each identified object individually, calculate its orientation angle and distance information relative to the current robot, and simulate the function of the “where pathway”. The object detection algorithm in the present invention adopts the DPM algorithm with strong robustness. However, at this stage, most object position recognition algorithms are estimated directly by combining the depth map with the position of the recognized object in the RGB map, and this type of method has a large calculation error. To solve this problem, the present invention proposes a object position recognition algorithm. By rotating the robot, the object to be detected is placed in the center of the field of view, and then the distance between the object and the robot is obtained by using the depth camera.

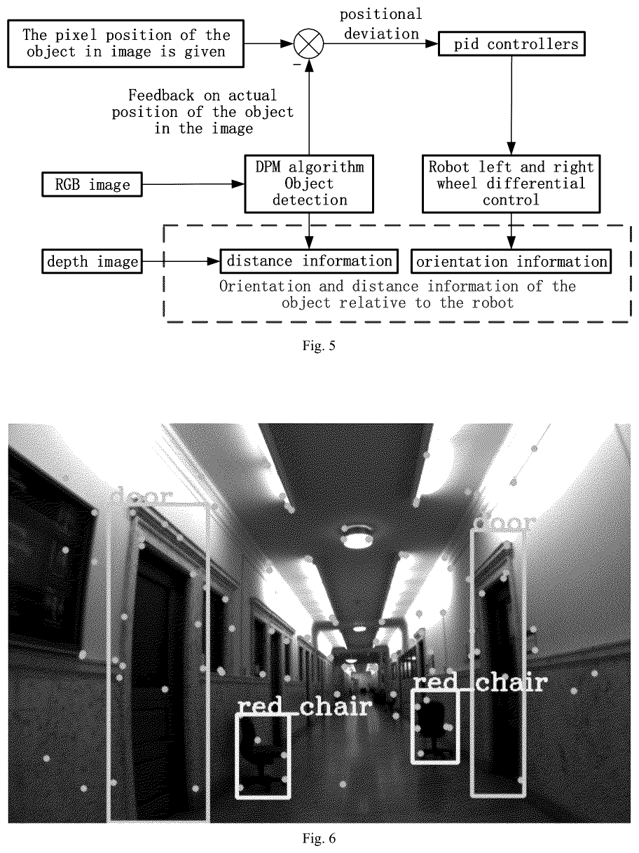

In actual physical experiment, RGB image pixels collected by the robot are set to 1920*1080, and the pixel value in center field of view is p_{graph_middle}=1920/2. The rotation control of the robot is realized through the differential speed of the left and right wheels, that is, when the left and right wheels of the robot move in opposite directions at the same speed, the robot can rotate in place, and the rotation speed is set to ω. FIG. 5 is a flow chart of the object position recognition algorithm, and the specific implementation steps of the algorithm are as follows:

When the robot explores in the environment, it will face a new scene every time it moves, and define i as the scene number. Firstly, the number of objects nᵢ^{object} in the i-th scene is identified by the DPM algorithm, and the current head-direction angle is Φ₀ⁱ. The serial number of the currently detected object in the i-th scene is j, and the attribute of the j-th object to be detected is defined as ρᵢⱼ. Then calculate the orientation angle information of each object in turn: calculate the average value of the left and right boundaries of the j-th object to be detected obtained by the DPM algorithm in the image, and obtain the pixel position of the center of the object in the horizontal direction in the image, set it as p_{object_middle}. In order to place the object to be detected in the center field of view, rotation speed of the robot is controlled by the PID algorithm for closed-loop control.

The mathematical expression of the current pixel deviation e_{object_middle} is:

e_{object_middle}=p_{graph_middle}−p_{object_middle} (25)

Then the mathematical expression of the given value of current rotation speed ω obtained by the PID algorithm is:

$$ω = {k}_{P} \cdot {e}_{object\_middle} + {k}_{I} \cdot \int {e}_{object\_middle} dt + {k}_{D} \cdot \frac{{de}_{object\_middle}}{dt} \qquad ( 26 )$$

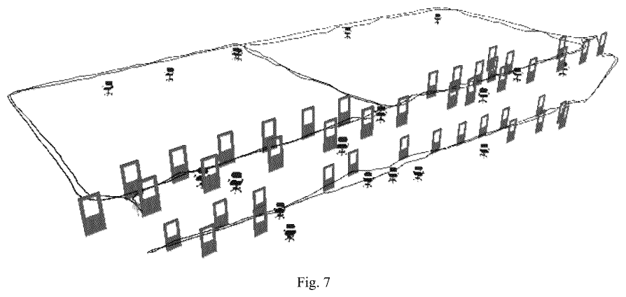

In formula (26), k_{P}, k_{I}, k_{D} respectively represent the proportional, integral, and differential coefficients of the PID controller, and the selection of their values is related to the actual physical environment and the hardware structure and configuration of the robot. When the object to be detected is placed in the center field of view, record the orientation angle Φ of the robot head at this time, then the direction angle of the j-th object in the i-th scene relative to the robot before rotation is Φᵢⱼ=Φ−Φ₀ⁱ. At the same time, the depth camera is used to obtain the distance dᵢⱼ between the robot and the object, through the above operations, the orientation angle and distance information of the j-th object relative to the robot at the current moment can be obtained. After the information of all objects in the current scene is obtained, rotate the robot's head-direction angle to Φ₀ⁱ, continue to explore and recognize in the environment. The acquisition of scenario information lays the foundation for the construction of subsequent cognitive maps. FIG. 6 is an effect diagram of using the DPM algorithm to identify objects in the actual physical environment.

### 4. Construction of Cognitive Nodes for Episodic Memory

Place cells in hippocampal CA1 area are neurons stimulated by angle, speed and visual information, and are the basic unit for constructing environmental cognitive maps. Therefore, a single place cell in hippocampal CA1 can be called as a cognitive node. A cognitive map consists of several cognitive nodes with topological relationships Cognitive nodes correspond to scenario information, and a new cognitive node will be established every time the robot moves.

The i-th cognitive node can be expressed by eⁱ, which stores current scene information and pose information, and its mathematical expression is shown in formula (1). Wherein, Φ₀ⁱ [symbol] (Xₑₙᵥⁱ, Yₑₙᵥⁱ) [symbol] (nᵢ^{object}, {ρᵢⱼ}, {Φᵢⱼ}, {dᵢⱼ}) represent the head-direction angle, position and scene information at the cognitive node, respectively. The head-direction angle and position were obtained from the entorhinal-hippocampal CA3 neural computing model; the scene information was obtained from the visual pathway computing model, and the position coordinates also represented the central coordinates of the firing field of the hippocampal CA1 place cells. There is also a connection between a single cognitive node and other cognitive nodes, and each cognitive node eⁱ has a topological connection relationship with its upper and lower cognitive nodes (that is, there is a topological connection relationship between adjacent cognitive nodes). When the current scenario information output by the visual pathway matches the scenario information stored in the generated cognitive nodes, the connection between the current cognitive point and the matching cognitive point is established.

The steps for judging whether the scenario information of two cognitive nodes match are as follows: if there are two cognitive nodes e^{a} and e^{b}, first judge whether the number of objects in the two scenarios is the same and whether the attributes of the corresponding objects are consistent, if one of the above conditions is not satisfied, it is judged that the two scenarios do not match; otherwise, by measuring whether the orientation angle information of each object in the scenario is consistent, the mathematical expression of the measurement function S(e^{a}, e^{b}) is:

$$S ( {e}^{a} , {e}^{b} ) = {μ}_{Φ} \frac{{\sum }_{j = 1}^{{n}_{i}^{object}} \vert {Φ}_{aj} - {Φ}_{bj} \vert}{{n}_{i}^{object}} + {μ}_{d} \frac{{\sum }_{j = 1}^{{n}_{i}^{object}} \vert {d}_{aj} - {d}_{bj} \vert}{{n}_{i}^{object}} \qquad ( 27 )$$

In formula (27), μ_{Φ} and μ_{d} represent the weights of direction information and distance information respectively, μ₁₀₁ +μ_{d}=1, and the values of the two should be selected in combination with the actual physical scene and the units of angle and distance. Generally, when the angle is in radians and the distance is in meters, the value of μ_{Φ} is between 0.1-0.3, and the value of μ_{d} is between 0.7-0.9. Set the matching threshold as Sₜₕ, and select an appropriate value according to the actual situation. When the value of the metric function is less than the matching threshold, it is judged that the two scenes match, and at this time the topological relationship between cognitive nodes e^{a} and e^{b} is established; and vice versa.

In the process of continuous accumulation of cognitive nodes, their relative errors are also accumulated, resulting in a mismatch between the position of the robot itself and the current actual position. Therefore, it is necessary to use its topology to adjust the position of cognitive nodes. It is known that the current cognitive node is eⁱ, and the cognitive node associated with it is e^{k}. This represents that there is a topological relationship between node eⁱ and node e^{k}. Then the mathematical expression of the pose correction of cognitive nodes eⁱ and e^{k} is as follows.

Firstly, calculate the change amount of Δxᵢₖ [symbol] Δyᵢₖ and ΔΦ₀^{ik} of the cognitive nodes, which is shown in formula (28).

$$\{ \begin{matrix}{d}_{i , k} = \sqrt{{( {X}_{e n v}^{i} - {X}_{e n v}^{k} )}^{2} + {( {Y}_{e n v}^{i} - {Y}_{e n v}^{k} )}^{2}} \\ Δ {x}_{i k} = {X}_{e n v}^{i} + {d}_{i k} * cos ( {Φ}_{0}^{i} + {Φ}_{0}^{k} ) \\ Δ {y}_{i k} = {Y}_{e n v}^{i} + {d}_{i k} * sin ( {Φ}_{0}^{i} + {Φ}_{0}^{k} ) \\ {Δ Φ}_{0}^{i k} = {Φ}_{0}^{k} - arctan ( ( {p}_{y}^{i} - {p}_{y}^{k} ) / ( {p}_{x}^{i} - {p}_{x}^{k} ) )\end{matrix} \qquad ( 28 )$$

In formula (28), Xₑₙᵥⁱ [symbol] Yₑₙᵥⁱ and Xₑₙᵥ^{k} [symbol] Yₑₙᵥ^{k} represent the horizontal and vertical coordinates of the place field's center corresponding to the cognitive points eⁱ and e^{k} respectively, dᵢₖ represents the distance between the center of the place field corresponding to the cognitive point eⁱ and e^{k}, Φ₀ⁱ and Φ₀^{k} respectively represents the head-direction angles at cognitive points eⁱ and e^{k}. After the change amount is obtained, the corrected node parameters can be iteratively calculated step by step according to the change amount, and the relevant mathematical expressions are shown in formula (29) and (30).

$$\{ \begin{matrix}{X}_{e n v}^{i} ( t + 1 ) = {X}_{e n v}^{i} ( t ) + δ ( {X}_{e n v}^{k} ( t ) - Δ {x}_{i k} ) \\ {Y}_{e n v}^{i} ( t + 1 ) = {Y}_{e n v}^{i} ( t ) + δ ( {Y}_{e n v}^{k} ( t ) - Δ {y}_{i k} ) \\ {X}_{e n v}^{k} ( t + 1 ) = {X}_{e n v}^{k} ( t ) - δ ( {X}_{e n v}^{k} ( t ) - Δ {x}_{i k} ) \\ {Y}_{e n v}^{k} ( t + 1 ) = {Y}_{e n v}^{k} ( t ) - δ ( {Y}_{e n v}^{k} ( t ) - Δ {y}_{i k} )\end{matrix} \qquad ( 29 )$$

$$\{ \begin{matrix}{Φ}_{0}^{i} ( t + 1 ) = {Φ}_{0}^{i} ( t ) + δ Δ {Φ}_{0}^{i k} \\ {Φ}_{0}^{k} ( t + 1 ) = {Φ}_{0}^{k} ( t ) - δ Δ {Φ}_{0}^{i k}\end{matrix} \qquad ( 30 )$$

In formula (29) and (30), t and t+1 represent the time before and after each iterative operation, respectively, and δ represents the correction rate of the cumulative error, which is 0.5. In the actual cognitive map construction process, as the number of iterations increases, the value of the map update amount gradually decreases. At this time, the effect of iteratively updating the map is not significant and consumes the computing time of the processor, which affects the real-time performance of the algorithm. Based on this, this invention proposes a method for judging the convergence of cognitive maps, the specific steps are as follows. First, define the map convergence at time t as Δd(t), and its mathematical expression is shown in formula (31).

$$Δ d ( t ) = {\sum }_{i = 1}^{{n}_{s u m}} {\sum }_{k = 1}^{{n}_{i}} ( \vert {X}_{e n v}^{i} ( t ) - {X}_{e n v}^{i} ( t - 1 ) \vert + \vert {Y}_{e n v}^{i} ( t ) - {Y}_{e n v}^{i} ( t - 1 ) \vert + \vert {Y}_{e n v}^{k} ( t ) - {Y}_{e n v}^{k} ( t - 1 ) \vert + \vert {Y}_{e n v}^{k} ( t ) - {Y}_{e n v}^{k} ( t - 1 ) \vert ) \qquad ( 31 )$$

In formula (31), nₛᵤₘ represents the total number of current cognitive nodes, and nᵢ represents the number of nodes associated with cognitive node i. Set the scale factor of the convergence criterion is σ, and the value is selected according to the actual situation, usually within the range of 0.0001-0.005. When Δd(t)−Δd(t+1)<σΔd(t+1), it is judged that there is no need to continue the map update iteration at this time; otherwise, continue to perform the update iteration of cognitive map construction. After obtaining the topological cognitive map of the environment and the scenario information, they can be fused to obtain the episodic cognitive map of the environment. The specific method is: according to the position of the robot in the physical coordinate system obtained above and the orientation angle and distance information of the object relative to the robot, the position of all objects in the physical coordinate system can be calculated, and each object is calculated according to the attribute and position information insert in the physical coordinate system including the topological map to obtain the episodic cognition map of the environmental expression. FIG. 7 is an effect diagram of the constructed episodic cognition map.

1. A method for constructing episodic memory model based on rat brain visual pathway and entorhinal-hippocampal cognitive mechanism, comprising the following steps:
step 1. a robot explores the environment, collects RGB image information of the environment through a camera, and collects head-direction angle and speed information of the robot through gyroscope and encoder;
step 2. input the head-direction angle and speed information into an entorhinal-hippocampus CA3 neural computing model to obtain the robot's position information in the environment;
step 3. input the RGB image information into a visual pathway computing model to obtain environmental features within robot's field of view, including the number of objects in the environment, attribute information of the objects, angles of the objects relative to the robot, and distances between objects and the robot;
step 4. construct cognitive nodes: the robot constructs a new cognitive node every time it moves, and continuously constructs cognitive nodes in the process of exploring environment; there are topological connections between adjacent cognitive nodes. among them, the i-th cognitive nodes are represented by eⁱ, which are used to store current scenario information, position, and head-direction angle; a mathematical expression of eⁱ is as follows;
eⁱ={Φ₀ⁱ, (Xₑₙᵥⁱ, Yₑₙᵥⁱ), (nᵢ^{object}, {ρᵢⱼ}, {Φᵢⱼ}, {dᵢⱼ})} (1)
wherein, Φ₀ⁱ represents the robot's head-direction angle at the i-th cognitive node, (Xₑₙᵥⁱ, Yₑₙᵥⁱ) represents the robot's position in the environment at the i-th cognitive node, (nᵢ^{object}, {ρᵢⱼ}, {Φᵢⱼ}, {dᵢⱼ}) represents the environmental features within the robot's field of view at the i-th cognitive node, and nᵢ^{object} represents the number of objects at the i-th cognitive node, ρᵢⱼ represents the attribute of the j-th object at the i-th cognitive node, Φᵢⱼ represents the orientation angle of the j-th object at the i-th cognitive node relative to the robot, and dᵢⱼ represents a distance between the j-th object at the i-th cognitive node and the robot;
step 5. construct an episodic cognition map of environmental expression;
step 2 further comprises the following steps:
s1.1 input the head-direction angle and speed information of robot into a firing model of stripe cells to obtain a firing rate of stripe cells;
s1.2 input the firing rate of stripe cells into a firing model of grid cells to obtain a firing rate of grid cells;
s1.3 input the firing rate of grid cells into a firing model of dentate gyrus neurons to obtain a firing rate of dentate gyrus neurons, and then input the firing rate of grid cells and the firing rate of dentate gyrus neurons into hippocampal CA3 place cell firing model, obtain a firing rate of hippocampal CA3 place cells;
s1.4 calculate the position of the robot in the environment based on the firing rate of hippocampal CA3 place cells;
a mathematical expression of the firing rate of stripe cells is given as:
Vₛₜᵣᵢₚₑ(t)=cos(2πf·∫v_{HD}dt)+cos(2πf_{d}·∫v_{HD}dt) (2)
in formula (2), t represents the time at the current moment, f represents an oscillation frequency of neuron cell body, f_{d} represents an oscillation frequency of neuron dendrites; ∫v_{HD}dt represents a path integral along a preferred direction angle Φ_{HD} of the stripe cells, where v_{HD} represents a component velocity of the rat at the preferred direction angle Φ_{HD}, and its mathematical expression is as follows:
v_{HD}=v cos(Φ−Φ_{HD}) (3)
in formula (3), v represents a current moving speed of the robot, and Φ represents a current head-direction angle of the robot, a mathematical expression of neuron dendritic oscillation frequency f_{d} can be obtained as:
f_{d}=f+B₁v cos(Φ−Φ_{HD}) (4)
where B₁ is a reciprocal of a wavelength of a stripe wave, and the grid cell firing model is obtained by superimposing the firing rates of three stripe cells with a difference of 120° in the preferred direction, the specific mathematical expression is:
g(t)=Π_{HD}(cos(2πf·∫v_{HD}dt)+cos(2π(f+Bv cos(Φ−Φ_{HD}))·∫v_{HD}dt)) (5)
in formula (5), values of the three stripe cell preferred direction angles Φ_{HD} are Φ_{g}+0°, Φ_{g}+120°, Φ_{g}+240° respectively, where Φ_{g} represents a deviation angle of the stripe cells, and its value ranges from random selection within 0°-360°; Φ_{g} also represents an orientation angle of a grid field; after the firing rate of grid cells is obtained, it is used as a forward input signal of the dentate gyrus neurons, and the mathematical expression of the excitatory input Iᵢ^{MEC}(t) received by the i-th dentate gyrus neuron is:
$${I}_{i}^{M E C} ( t ) = {\sum }_{j = 1}^{{n}_{grid}} {W}_{i j} {g}_{j} ( t ) \qquad ( 6 )$$
in formula (6), i and j represent numbers of dentate gyrus neurons and grid cells respectively, gⱼ(t) represents the firing rate of the j-th grid cell, and n_{grid} represents the number of grid cells; W represents an excitatory input connection weight matrix, where Wᵢⱼ represents a connection weight from the j-th grid cell to the i-th dentate gyrus neuron, and the calculation formula of each connection weight is as follows:
$$W ( s ) = \frac{s}{0.2} ( \frac{s}{s + 0.0314} ) \qquad ( 7 )$$
in formula (7), s represents synapse size, and a size of s is randomly selected in the range of (0-0.2)μm²; each size of s corresponds to its proportion in all synapses P(s) roughly obeys the following mathematical expression:
$$P ( s ) = {A}_{1} ( 1 - {e}^{- \frac{s}{{σ}_{1}}} ) ( {e}^{- \frac{s}{{σ}_{2}}} + {B}_{2} {e}^{- \frac{s}{{σ}_{3}}} ) \qquad ( 8 )$$
in formula (8), A=100.7, B=0.02, σ₁=0.022, σ₂=0.018, σ₃=0.15; the excitatory input connection weight matrix W can be assigned by formula (7) and formula (8), so as to realize the excitatory transmission from grid cells to dentate gyrus neurons; firing activity of dentate gyrus neurons within a given spatial region is subject to a WTA learning rule that describes competing activity arising from gamma-frequency feedback inhibition; the mathematical expression of the firing rate of dentate gyrus neurons is:
Fᵢ^{dentate}(t)=Iᵢ^{MEC}(t)·H(Iᵢ^{MEC}(t)−(1−k₁)·Iₘₐₓ^{MEC}) (9)
in formula (9), Fᵢ^{dentate} represents the firing rate of dentate gyrus neurons, k₁ is 0.1, Iₘₐₓ^{MEC} represents a maximum value of grid cell forward input received by dentate gyrus neurons; H(x) is a rectification function, when x>0, H(x)=1; otherwise, when x≤0, the function value is 0; and the excitatory input signal from the dentate gyrus neuron to the hippocampal CA3 place cell is as follows:
$${I}_{i}^{d e n t a t e} ( t ) = {\sum }_{j = 1}^{{n}_{d e n t a t e}} {Ω}_{i j} \frac{{F}_{i}^{d e n t a t e} ( t )}{{F}_{max}^{d e n t a t e}} \qquad ( 10 )$$
in formula (10), i and j represent serial numbers of hippocampal CA3 place cells and dentate gyrus neurons respectively, and n_{dentate} represents the number of dentate gyrus neurons, which is set to 1000; Fₘₐₓ^{dentate} represents a maximum firing rate of neurons in the dentate gyrus; since Fᵢ^{dentate}(t) is always greater than zero, dividing it by the maximum firing rate is similar to normalization; Ω represents an excitatory input connection weight matrix, where Ωᵢⱼ represents the connection weight from the j-th dentate gyrus neuron to the i-th hippocampal CA3 place cell, and a value of Ωᵢⱼ ranges from 0-1; distribution function of the connection weight value is defined as a non-negative Gaussian distribution, and the mathematical expression is as follows:
$$P ( Ω ) = {A}_{2} {e}^{- \frac{{( Ω - 1 )}^{2}}{2 {( σ / μ )}^{2}}} \qquad ( 11 )$$
in formula (11), A₂=1.033, μ=24, σ=13; the excitatory input connection weight matrix Ω can be assigned by formula (11), so as to realize the excitatory transmission from the dentate gyrus neurons to the hippocampal CA3 place cells; the hippocampal CA3 place cells of the hippocampus receive forward input from the neurons of the entorhinal cortex and the dentate gyrus at the same time, so the mathematical expression of the total excitatory input signal received by the hippocampal CA3 place cells is:
Iᵢ^{CA3}(t)=Iᵢ^{MEC}(t)+Iₐᵥ^{MEC}(t)Iᵢ^{dentate}(t) (12)
in formula (12), Iᵢ^{MEC}(t) and Iᵢ^{dentate}(t) are respectively forward input signals of grid cells and dentate gyrus neurons, and Iₐᵥ^{MEC}(t) represents an average strength of grid cell forward input signals, and its mathematical expression is:
$${I}_{av}^{MEC} ( t ) = \frac{1}{{n}_{CA 3}} {\sum }_{i = 1}^{{n}_{CA 3}} [ \int {I}_{i}^{MEC} ( t ) d t ] \qquad ( 13 )$$
in formula (13), n_{CA3} represents the number of hippocampal CA3 place cells, and the mathematical expression of the hippocampal CA3 place cell firing model is as follows:
Fᵢ^{CA3}(t)=Iᵢ^{CA3}(t)·H(Iᵢ^{CA3}(t)−(1−k₂)·Iₘₐₓ^{CA3}) (14)
in formula (14), Iₘₐₓ^{CA3} represents a maximum value of total excitation input signal received by hippocampal CA3 place cells, and a value of k₂ is 0.1;
s1.4 further includes the following steps:
construct a place cell plate model which is capable for encoding a given spatial region; a shape of the cell plate is a square, and a side length of the cell plate is Nₓ, and obtain position coordinates of the robot in given spatial region; wherein, a position of current robot in the coding space region of current place cell plate is calculated by formula (15):
$$\{ \begin{matrix}{P}_{x}^{t} = {N}_{x} arctan ( \frac{{\sum }_{j = 1}^{{N}_{x}} ( sin \frac{2 j π}{{N}_{x}} {\sum }_{i = 1}^{{N}_{x}} {p}_{i , j}^{t} )}{{\sum }_{j = 1}^{{N}_{x}} ( cos \frac{2 j π}{{N}_{x}} {\sum }_{i = 1}^{{N}_{x}} {p}_{i , j}^{t} )} ) / 2 π \\ {P}_{y}^{t} = {N}_{x} arctan ( \frac{{\sum }_{i = 1}^{{N}_{x}} ( sin \frac{2 i π}{{N}_{x}} {\sum }_{j = 1}^{{N}_{x}} {p}_{i , j}^{t} )}{{\sum }_{i = 1}^{{N}_{x}} ( cos \frac{2 i π}{{N}_{x}} {\sum }_{j = 1}^{{N}_{x}} {p}_{i , j}^{t} )} ) / 2 π\end{matrix} \qquad ( 15 )$$
in formula (15), Pₓ^{t} and P_{y}^{t} represent abscissa and ordinate of an excitatory activity packet on the place cell plate at time t, respectively, and p_{i,j}^{t} represent the firing rate of place cells in row i and column j on the cell plate at time t, which is calculated according to the hippocampal CA3 place cell firing rate;
s1.4.2, using physiological characteristic of border cells with specific firing effects on area boundary, realize periodic reset of the firing of stripe cells, and obtain the position coordinates of the robot in any size space area: the specific implementation method is as follows: at the initial moment, the rat is set to be located in a center of the square area encoded by the place cell plate, and when the rat reaches any boundary of the given encoding area space, a path integration ∫v_{HD}dt of all stripe cells in the direction of preferred angle Φ_{HD} is set to zero, so that the rat is in a center of a positive direction area coded by the place cell plate after reset; in this way, every time the firing reset of stripe cells is completed, the place cell plate can immediately generate a code for a new spatial region, thereby completing the robot's position cognition for any size space;
an initial position of the robot movement is located in the center of the square area encoded by the place cell plate; a physical coordinate system is defined with the initial movement position as origin, and the horizontal direction of place cell plate is positive direction of X-axis; the physical coordinate systems mentioned below are all for this coordinate system; then the mathematical expression of the position coordinates (Xₑₙᵥ^{t}, Yₑₙᵥ^{t}) of the robot in any size space area is as follows:
$$( {X}_{env}^{t} {Y}_{env}^{t} ) = ( β ( {P}_{x}^{t} - \frac{{N}_{x}}{2} ) + {Q}_{x} , β ( {P}_{y}^{t} - \frac{{N}_{x}}{2} ) + {Q}_{y} ) \qquad ( 16 )$$
in formula (16), β is a proportional coefficient for transforming the coordinates on the place cell plate to the real position coordinates, and its value is the ratio of side length L of the square coding area to the side length Nₓ of the place cell plate; Q_{X} and Q_{Y} respectively represent the horizontal and vertical coordinates of the rat in any size space area when the place cell plate was reset last time, which provides accurate position information for the subsequent construction of cognitive node;
a visual pathway computing model includes “what pathway” and “where pathway”, where the “what pathway” model adopts the DPM algorithm, and its input is the input of environmental RGB image information, which is used to obtain the number and attribute information of objects in the environment;
the “where pathway” model is used to obtain the orientation angle and distance information of the object relative to the robot, including the direction relative to the robot and the distance from the robot;
the “where pathway” working process is: when the robot is exploring in the environment, the PID algorithm is adopted for closed-loop control of the robot's rotation speed, so that the object to be detected is placed in the center of the field of vision; the robot will face a new scene every time it moves, and i is defined as the scene sequence number; firstly, the number of objects in the i-th scene is identified by DPM algorithm, set as nᵢ^{object}, the current head-direction angle is Φ₀ⁱ, and the sequence number of objects currently detected in the i-th scene is j;
then, the orientation angle information of each object is solved successively; the mathematical expression of the current pixel deviation e_{object_middle} is:
e_{object_middle}=p_{graph_middle}−p_{object_middle} (17)
p_{graph_middle} represents a pixel value in the center of the field of view, p_{object_middle} represents an average position of the left and right boundaries of the object to be detected in the image, and the mathematical expression of the given value of the current rotation speed ω obtained by the PID algorithm is:
$$ω = {k}_{p} \cdot {e}_{object\_middle} + {k}_{I} \cdot \int {e}_{object\_middle} dt + {k}_{D} \cdot \frac{{de}_{object\_middle}}{dt} \qquad ( 18 )$$
when the object to be detected is placed in the center of the field of view, record the orientation angle Φ of the robot head at this time, then the direction angle of the j-th object in the i-th scene relative to the robot before rotation, Φᵢⱼ=Φ−Φ₀ⁱ, at the same time, the distance dᵢⱼ between the robot and object to be measured is obtained by the depth camera; through the above operations, the orientation angle and distance information of the j-th object relative to the robot at the current moment can be obtained;
after the information of all objects in the current scene is obtained, the head-direction angle of the robot is rotated to Φ₀ⁱ again to continue the exploration and cognition in the environment;
step 5 further comprises the following steps:
S5.1 through a similar scene measurement algorithm, establish a topological connection relationship between cognitive nodes with similar scenario information, so as to expand the topological connection relationship between adjacent cognitive nodes;
S5.2 use the topological relationship among all cognitive nodes to correct the cumulative error of the head-direction angle and position of the mobile robot during the exploration process, and construct a topological cognitive map;
S5.3 calculate the position of environmental objects in the physical coordinate system and calibrate them in the topological map to realize the construction of the environmental episodic cognitive map;
a specific algorithm for measuring similar scenes is as follows:
set two cognitive nodes e^{a} and e^{b}, first judge whether the number of objects in the two scenarios is the same and whether the attributes of the corresponding objects are consistent, if one of the above conditions is not satisfied, it is judged that the two scenarios do not match; otherwise, by measuring whether the orientation angle information of each object in the scenario is consistent, the mathematical expression of the measurement function S(e^{a}, e^{b}) is:
$$S ( {e}^{a} , {e}^{b} ) = {μ}_{Φ} \frac{{\sum }_{j = 1}^{{n}_{i}^{object}} \vert {Φ}_{aj} - {Φ}_{b j} \vert}{{n}_{i}^{o b j e c t}} + {μ}_{d} \frac{{\sum }_{j = 1}^{{n}_{i}^{object}} \vert {d}_{aj} - {d}_{b j} \vert}{{n}_{i}^{o b j e c t}} \qquad ( 19 )$$
in formula (19), μ_{Φ} and μ_{d} represent weights of direction information and distance information respectively, μ_{Φ}+μ_{d}=1, set a matching threshold as Sₜₕ, and select an appropriate value according to the actual situation; when a value of the metric function is less than the matching threshold, it is judged that the two scenes match, and at this time the topological relationship between cognitive nodes e^{a} and e^{b} is established;
S5.2 specifically includes:
it is known that the current cognitive node is eⁱ, and the cognitive node associated with it is e^{k}; this represents that there is a topological relationship between node eⁱ and node e^{k}; then the mathematical expression of the pose correction of cognitive nodes eⁱ and e^{k} is as follows:
firstly, calculate the change amount of Δxᵢₖ [symbol] Δyᵢₖ and ΔΦ₀^{ik} of the cognitive nodes, which is shown in formula (20);
$$\{ \begin{matrix}{d}_{ik} = \sqrt{{( {X}_{env}^{i} - {X}_{env}^{k} )}^{2} + {( {Y}_{env}^{i} - {Y}_{env}^{k} )}^{2}} \\ Δ {x}_{ik} = {X}_{env}^{i} + {d}_{ik} * cos ( {Φ}_{0}^{i} + {Φ}_{0}^{k} ) \\ Δ {y}_{ik} = {Y}_{env}^{i} + {d}_{ik} * sin ( {Φ}_{0}^{i} + {Φ}_{0}^{k} ) \\ {ΔΦ}_{0}^{ik} = {Φ}_{0}^{k} - arctan ( ( {Y}_{env}^{i} - {Y}_{env}^{i} ) / ( {X}_{env}^{i} - {X}_{env}^{k} ) )\end{matrix} \qquad ( 20 )$$
in formula (20), Xₑₙᵥⁱ [symbol] Yₑₙᵥⁱ and Xₑₙᵥ^{k} [symbol] Yₑₙᵥ^{k} represent the horizontal and vertical coordinates of the place field's center corresponding to the cognitive points eⁱ and e^{k} respectively, dᵢₖ represents the distance between the place field's center corresponding to the cognitive point eⁱ and e^{k}, Φ₀ⁱ and Φ₀^{k} respectively represents the head-direction angles at cognitive points eⁱ and e^{k}; after the change amount is obtained, the corrected node parameters can be iteratively calculated step by step according to the change amount, and the relevant mathematical expressions are shown in formula (21) and (22); in formula (21) and (22), t and t+1 represent the time before and after each iterative operation, respectively, and δ represents the correction rate of the cumulative error;
$$\{ \begin{matrix}{X}_{e n v}^{i} ( t + 1 ) = {X}_{e n v}^{i} ( t ) + δ ( {X}_{e n v}^{k} ( t ) - Δ {x}_{i k} ) \\ {Y}_{e n v}^{i} ( t + 1 ) = {Y}_{e n v}^{i} ( t ) + δ ( {Y}_{e n v}^{k} ( t ) - Δ {y}_{i k} ) \\ {X}_{e n v}^{k} ( t + 1 ) = {X}_{e n v}^{k} ( t ) - δ ( {X}_{e n v}^{k} ( t ) - Δ {x}_{i k} ) \\ {Y}_{e n v}^{k} ( t + 1 ) = {Y}_{e n v}^{k} ( t ) - δ ( {Y}_{e n v}^{k} ( t ) - Δ {y}_{i k} )\end{matrix} \qquad ( 21 )$$
$$\{ \begin{matrix}{Φ}_{0}^{i} ( t + 1 ) = {Φ}_{0}^{i} ( t ) + δ Δ {Φ}_{0}^{i k} \\ {Φ}_{0}^{k} ( t + 1 ) = {Φ}_{0}^{k} ( t ) - δ Δ {Φ}_{0}^{i k}\end{matrix} \qquad ( 22 )$$
a map convergence criterion algorithm is added after S5.2, to improve the real-time performance of the map construction process, define the map convergence at time t as Δd(t), and its mathematical expression is as follows:
$$Δ d ( t ) = {\sum }_{i = 1}^{{n}_{s u m}} {\sum }_{k = 1}^{{n}_{i}} ( \vert {X}_{e n v}^{i} ( t ) - {X}_{e n v}^{i} ( t - 1 ) \vert + \vert {Y}_{e n v}^{i} ( t ) - {Y}_{e n v}^{i} ( t - 1 ) \vert + \vert {Y}_{e n v}^{k} ( t ) - {Y}_{e n v}^{k} ( t - 1 ) \vert + \vert {Y}_{e n v}^{k} ( t ) - {Y}_{e n v}^{k} ( t - 1 ) \vert ) \qquad ( 23 )$$
in formula (23), nₛᵤₘ represents the total number of current cognitive nodes, and nᵢ represents the number of nodes associated with cognitive node i; set the scale factor of the convergence criterion is σ, when Δd(t)−Δd(t+1)<σΔd(t+1), it is judged that there is no need to continue the map update iteration at this time; otherwise, continue to perform the update iteration of cognitive map construction;
the specific steps in step S5.3 are as follows:
after obtaining the topological cognitive map and scenario information of the environment, the two can be integrated to obtain the episodic cognitive map of the environment, the specific method is as follows: according to the position of the robot in physical coordinate system and the orientation angle and distance information of the object relative to the robot obtained above, the positions of all objects in the physical coordinate system can be calculated; insert each object in physical coordinate system containing the topological map according to its attributes and position information to obtain the episodic cognitive map of the environment representation.
